(19) United States
(12) Patent Application Publication
(10) Pub. No.: US 2006/0129469 A1
(43) Pub. Date: Jun. 15, 2006

(54) "PLAN" fund

(76) Inventor: Maureen H. Schmidlin, Roebling, NJ (US)

Correspondence Address: Maureen H. Schmidlin, 13 A Maple Avenue, Roebling, NJ, 08554, US

(21) Appl. No.: 11/008,520

(22) Filed: Dec. 9, 2004

(51) Int. Cl. G06Q 40/00

(52) U.S. Cl. 705/35

(57) ABSTRACT

Couple would make list of all friends/family. List would be typed into an internet program and used to set up empty accounts. Program would also print the appropriate mailing information to insert into couples' wedding announcements/invitations. Mailings would contain information about how to add money to the couple's future home account instead of purchasing traditional gifts. Mailings would contain the website address of an internet program to help guests make contributions. The website URL, seemingly specific to each guest, allows them to add money to the account by credit card or direct deposit on a one time, periodic or whenever desired basis. Paper based deposit forms would also be available. The internet system will archive guest's information and send it, encrypted, in required formats of XML, to the host financial institution. Couple could login to view by percentage/dollar/ or graphic illustration, total progress of account.

### SUMMARY

A Preferred Lifestart Account for Newlyweds (the “PLAN”) fund is an interest-bearing savings account maintained by a financial institution for the benefit of to-be-wed and recently-wed couples, through which friends, family, and others could make monetary gifts that would be used at a subsequent time towards: (i) the purchase of a home; or (ii) the necessary qualifying down-payment in order to be eligible to be approved for a mortgage to purchase a home. The participating financial institution could provide the PLAN fund with a better rate of interest than ordinary savings accounts or accept matching gift contributions by wedding service vendors. The financial institution could also set monetary penalties for pre-mature or non-eligible withdrawals from the PLAN account. After its establishment, the PLAN find could receive monetary gifts at any time and receive additional deposits from the account holders. Upon the successful purchase of a home, the PLAN fund could convert to a savings account usable for any purpose at the financial institution's prevailing rate of interest.

FACTS*: Social Considerations
2.3 million couples wed every year in the U.S. (6,400 weddings per day);
Average age of a bride, 25.3;
Average age of a groom, 26.9;
Two-thirds of those getting married have never been married before; Financial Considerations
$72 billion per year spent on weddings;
$19 billion per year spent on wedding gift registries;
Average wedding budget, $20,000;
Average number of guests invited to a wedding, 178;
Most wedding guests spend between $70 and $100 on a gift;
Over 91% of all to-be-weds register for gifts. The couple receives gifts from an average of 200 guests.

### DETAILS

In today's increasingly expensive housing market, many young couples struggle to purchase their first home. Factors that make the initial home purchase a struggle for newly wed couples include limited assets and collateral, and typically entry level/lower paying jobs. These factors contribute to a financially-disadvantaged position from which to maximize their potential entry into the real estate market. Traditionally, to-be-wed couples register with department stores and specialty shops to acquire non-appreciating assets such as dishes, appliances and consumer electronics. Consequently, the gift registry industry has grown to realize $19 billion in annual sales. From a practical perspective, the acquisition of such items do little to enhance the cash position of newlywed couples.

For millions of Americans, their home is their primary asset. Current appreciation trends in many major real estate markets, especially in urban regions along the east and west coasts of the United States of America, result in double digit percentage increases in home values annually. A young couple could be priced out of an aggressive real estate market within a few years of marriage without a plan to acquire assets that could be used to purchase a home or qualify for home financing. Lenders typically consider a mortgage applicant's assets as a key component of their decision whether to commit to a mortgage. By accumulating assets designated for a home purchase, a PLAN fund would allow the couple to enter the housing market at an earlier point and maximize their real estate purchase power by improving their cash equity position. In aggressive real estate markets, the home-owning couple should then be able to reap the benefits of rising home values sooner.

For example, in 2003 the median home price across the U.S.A was $150,900. An average wedding party consisting of 178 guests, contributing an average gift of $85 per person, would collectively generate $15,130, or slightly more than 10% of the median purchase price of the home. This figure does not include the money that may be gifted directly into the PLAN fund for other wedding related events, such as the engagement party and bridal shower, or gifts from third-party stakeholders, such as wedding vendors.

A couple or the couple's family could establish the PLAN fund at a participating financial institution, and then inform family, friends and prospective wedding guests of the find's existence and how to make a gift to it.

Major financial institutions including banking and mortgage companies, and real estate agencies, are examples of the types of businesses that could establish, promote and/or maintain a PLAN fund.

Possible PLAN fund enhancements offered by a participating financial institution could include (but not be limited to):
A “matching gift” amount raised from businesses that provide wedding services; or
Interest rate enhancements based on the amount of money in the account and/or commitments to maintain funds for a specified amount of time.

Participating businesses would benefit by:
Capturing and managing significant capital, currently spent on consumer goods;
Directing/leveraging/outsourcing accounts to strategic industry partners;
Generating free advertising exposure to the thousands of people who attend weddings every year; and
Cultivating relationships and future investment/business opportunities with newlywed couples at the inception of their economic viability.

### *STATISTICAL SOURCES

U.S. Census Bureau (http://www.census.gov/Press-Release/www/2003/cb03ff02.html)

The Association for Wedding Professionals International (http://www.afwpi.com/wedstats)

The Knot (http://www.theknot.com/au industrystats.shtml)

Sellthebride.com (http://www.sellthebride.com/tipsstats.htm)

American Demographics

Bride's Millennium Report

Bride's Magazine

1. I, Maureen H. Schmidlin, residing at 1319 Maple Avenue, Roebling, N.J., 08554, hereby request that the U.S. patent and Trademark Office issue a utility patent to me to protect a new method of doing business as detailed below:
A Preferred Lifestart Account for Newlyweds (the “PLAN”) fund is an interest-bearing savings account maintained by a financial institution for the benefit of to-be-wed and recently-wed couples, through which friends, family, and others could make monetary gifts that would be used at a subsequent time towards: (i) the purchase of a home; or (ii) the necessary qualifying down-payment in order to be eligible to be approved for a mortgage to purchase a home. The participating financial institution could provide the PLAN fund with a better rate of interest than ordinary savings accounts or accept matching gift contributions by wedding service vendors. The financial institution could also set monetary penalties for pre-mature or non-eligible withdrawals from the PLAN account. After its establishment, the PLAN fund could receive monetary gifts at any time and receive additional deposits from the account holders. Upon the successful purchase of a home, the PLAN fund could convert to a savings account usable for any purpose at the financial institution's prevailing rate of interest.
